(19) United States
(12) Patent Application Publication
(10) Pub. No.: US 2011/0260636 A1
(43) Pub. Date: Oct. 27, 2011

(54) LED LAMP

(76) Inventors: Iurii N. Samoilenko, Kiev (UA); Valeriy S. Galuschak, Volgogradskaya Obl (RU)

(21) Appl. No.: 13/132,758

(22) PCT Filed: Oct. 9, 2009
(86) PCT No.: PCT/UA2009/000048

§ 371 Date: Jul. 9, 2011

(51) Int. Cl. H05B 37/02

(52) U.S. Cl. 315/232

(57) ABSTRACT

The invention relates to light sources having an ultra-low active-energy consumption. The LED lamp of the present invention includes a voltage down-converter (1) in the form of two capacitors (2, 3), one of which is a power bleed capacitor, and at least one pair of light diodes connected back-to-back and in parallel (5, 6). According to the invention, in order to reduce the reactive current in the supply circuit, an induction (8) is coupled in series with the light diodes (5, 6) and defines an electric oscillating circuit (9) together with the power bleed capacitor (3) according to one variant of the invention, and together with the output capacitor (11) and the light diodes (5, 6) according to another variant. The variants of the invention for making a LED lamp make it possible to achieve, according to a relatively simple production process, an ultra-low active electric-energy consumption for lighting purposes and to reduce the current charge on the supply circuit and, accordingly, to reduce electric energy losses in the circuit, and at least one pair of light-emitting diodes connected back-to-back and in parallel (5, 6). According to the invention, in order to reduce the reactive current in the supply circuit, an inductor (8) is coupled in series with the light-emitting diodes (5, 6) and defines an electric oscillating circuit (9) together with the power bleed capacitor (3) according to one variant of the invention, and together with the output capacitor (11) and the light-emitting diodes (5, 6) according to another variant. The variants of the invention for making a LED lamp make it possible to achieve, according to a relatively simple production process, an ultra-low active electric-energy consumption for lighting purposes and to reduce the current charge on the supply circuit and, accordingly, to reduce electric energy losses in the circuit.

### FIELD OF THE INVENTION

The invention relates to light sources and particularly deals with light-emitting diode (LED) lamps which can be used for both outdoor and indoor lighting and have ultra-low active energy consumption.

### BACKGROUND OF THE INVENTION

A single chain aperiodic brute-force filter with a 600 Hz locking circuit, comprising an input, an output and a general terminal for respectively connecting a rectifier and a load, a reactor connected in series between the input and output terminals, a capacitor connected in parallel to the load, is known from RU, 33675,U. A capacitor is further included in such a filter, which is connected in parallel to the reactor, said capacitor and the reactor forming a locking circuit set for the frequency of 600 Hz. A disadvantage of this known filter is that it can not be used in lighting equipment.

A direct frequency converter made with the involvement of a push-pull arrangement, having a zero output at a supply-line source of AC voltage and a separate control over two major current drivers, each of which is made as a monophase bridge voltage inverter with four transistor switches connected in parallel with bypass diodes, is known from RU,2192089. The inverter is connected to plates of a charge storage polarized capacitor through DC terminals, while it connects a power supply source with a common load circuit through AC current terminals with the involvement of an impedance matching inductor. Control is performed automatically based on comparison between current setting and feedback signals via high-frequency turning on and turning off a respective pair of transistor switches, which is accompanied by two-way energy exchange between the storage capacitor and the inductor and obtaining current of the set shape in the load circuit. Such a technical solution allows improving reliability, but it is not possible to use the same in lighting devices.

The closest prior art is constituted by a light-emitting diode lamp comprising a step-down voltage converter electrically connected with light-emitting diodes and used to maintain their power supply level (UA,42762, U). The step-down voltage converter used in this lamp is made as a chain of capacitors connected in series, one of which is a power bleed capacitor, and each pair of light-emitting diodes is mounted back-to-back and in parallel and connected to the power bleed capacitor.

A disadvantage of such a known light-emitting diode lamp is that it generates high reactive current in a power network, which increases with the increase of light-emitting diode lamp power.

The problem solved by the invention is to develop a light-emitting diode lamp in which reactive current in the power network would be decreased due to the use of an electric oscillating circuit tuned for current resonance, which, respectively allows to reduce energy losses.

### DISCLOSURE OF THE INVENTION

The said problem is solved by a light-emitting diode lamp according to the invention, comprising a step-down voltage converter in the form of a chain of two capacitors connected in series, one of which is a power bleed capacitor, a discharge resistor connected to the input of the down-converter, and at least one pair of light-emitting diodes mounted back-to-back and in parallel and connected to the power bleed capacitor, wherein an inductor is coupled in series with each pair of light-emitting diodes, creating, together with the power bleed capacitor and light-emitting diodes, an electric oscillating circuit tuned for current resonance.

According to yet another aspect of the invention, in order to solve the mentioned technical problem and to ensure that the said electric oscillating circuit can further operate at different frequencies, the light-emitting diode lamp includes a frequency converter connected to the power bleed capacitor and having an output capacitor, and an inductor is coupled in series with each pair of light-emitting diodes, creating, together with the output capacitor of the frequency converter and light-emitting diodes, an electric oscillating circuit tuned for current resonance.

The proposed technical solution allows ensuring highly efficient performance of a light-emitting diode lamp, reducing current load in the power supply circuit, and, as a result, reducing energy losses in the power supply circuit.

### BRIEF DESCRIPTION OF THE DRAWINGS

The invention is further described in more details with reference to the accompanying drawings where

FIG. 1 is a diagram of the light-emitting diode lamp according to one aspect of the invention, providing the use of an inductor

FIG. 2 is a diagram of yet another aspect of the invention providing for the use of a frequency converter and an additional capacitor.

### BEST MODE FOR CARRYING OUT THE INVENTION

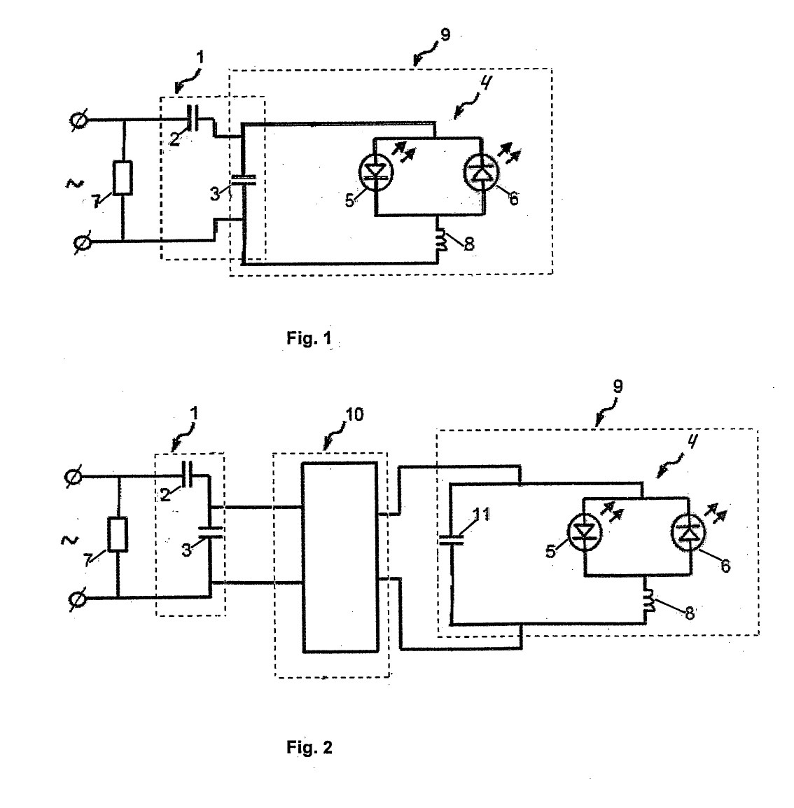

As shown in FIG. 1, the light-emitting diode lamp according to the invention comprises a step-down voltage converter 1 which is made according to the invention as two capacitors 2, 3 connected in series, one of which is a power bleed capacitor (the power bleed capacitor is marked with reference number 3 on the drawings). The claimed light-emitting diode lamp comprises at least one pair 4 of the light-emitting diodes 5, 6 mounted back-to-back and in parallel, connected to the power bleed capacitor 3. The number of pairs of light-emitting diodes in the lamp is chosen depending on the conditions in which a respective level of lighting needs to be achieved.

In order to discharge collected charge in the capacitors 2, 3, a discharge resistor 7 is installed at the input of the voltage converter 1. The rated resistance of the discharge resistor 7 is set in the range from ones to tens of mOhm.

According to the invention, in order to reduce reactive current in the power supply circuit, an inductor 8 is coupled in series with the light-emitting diodes, creating, together with the power bleed capacitor 3 and the light-emitting diodes 5, 6, an electric oscillating circuit 9 tuned for current resonance, while resonant current in the branch of the light-emitting diodes 5, 6 and the inductor 8 must be equal to the rated working current of the light-emitting diodes.

According to yet another aspect of the present invention, to ensure that the electric oscillating circuit 9 can operate at frequencies other than the frequency of alternating current in the power supply circuit, the power bleed capacitor 3 is connected to a frequency converter 10 (FIG. 2) having at its output a capacitor 11 creating, together with the light-emitting diodes 5, 6 and the inductor 8, an electric oscillating circuit 9 tuned for current resonance.

The rated values of the inductor 8 and capacitor 11 at the given resistance of the light-emitting diodes 5,6 is chosen for the conditions of current resonance in the electric oscillating circuit 9 for the working frequency of the frequency converter 10, which ranges from fractions to hundreds of kilohertz. At the same time, the resonant current in the branch of the light-emitting diodes 5, 6 and the inductor must be equal to the rated working current of the light-emitting diodes.

Thus, the proposed embodiments of the light-emitting diode lamp according to the invention, being easy in manufacture, allow to ensure ultra low consumption of active electric energy for lighting and to reduce current load on power network, which results in the reduction of losses of electric energy in the network.

The use of the claimed light-emitting diode lamp as an outdoor and indoor lighting source will make it possible to significantly cut on expenses covering consumed electricity.

1. A light-emitting diode lamp, comprising a step-down voltage converter in the form of a chain of two capacitors connected in series, one of which is a power bleed capacitor, a discharge resistor connected to the input of the down-converter, and at least one pair of light-emitting diodes mounted back-to-back and in parallel and connected to the power bleed capacitor, characterized in that an inductor is coupled in series with each pair of light-emitting diodes, creating, together with the power bleed capacitor and light-emitting diodes, an electric oscillating circuit tuned for current resonance.

2. A light-emitting diode lamp, comprising a step-down voltage converter in the form of a chain of two capacitors connected in series, one of which is a power bleed capacitor, a discharge resistor connected to the input of the down-converter, and at least one pair of light-emitting diodes mounted back-to-back and in parallel and connected to the power bleed capacitor, characterized in that it includes a frequency converter connected to the power bleed capacitor and having an output capacitor, and an inductor is coupled in series with each pair of light-emitting diodes, creating, together with the output capacitor of the frequency converter and light-emitting diodes, an electric oscillating circuit tuned for current resonance.
